(19) United States
(12) Patent Application Publication
(10) Pub. No.: US 2017/0010702 A1
(43) Pub. Date: Jan. 12, 2017

(54) METHOD OF DETECTING TOUCH POSITION AND TOUCH APPARATUS THEREOF

(71) Applicant: Wistron Corporation, New Taipei City (TW)

(72) Inventors: You-Jyun Syu, New Taipei City (TW); Ching-An Cho, New Taipei City (TW); Kuo-Ting Huang, New Taipei City (TW); Yu-Yen Chen, New Taipei City (TW)

(21) Appl. No.: 14/944,234

(22) Filed: Nov. 18, 2015

(30) Foreign Application Priority Data
Jul. 8, 2015 (TW) 104122093

(51) Int. Cl. G06F 3/041

(52) U.S. Cl. CPC G06F 3/041; G06F 2203/04104

(57) ABSTRACT

A method of detecting a touch position and a touch apparatus thereof are provided. At least three intervally distributed light sensing devices are provided to obtain a plurality of touch information. Based on peak values of the touch information, a total number of touched points is determined. When the total number is larger than 1, touched points on a touch surface are calculated. Touched points being examined corresponding to one of the peak values of a first touch information are obtained. According to distance values related to the touched points being examined, a first and a second to-be-examined touched point are selected. Whether the first and the second to-be-examined touched points are simultaneously corresponding to any one of the peak values of each touch information is determined. If the determination is positive, then a touch position is determined from the first and the second to-be-examined touched points.

### CROSS-REFERENCE TO RELATED APPLICATION

This application claims the priority benefit of Taiwan application serial no. 104122093, filed on Jul. 8, 2015. The entirety of the above-mentioned patent application is hereby incorporated by reference herein and made a part of this specification.

### BACKGROUND

Field of the Invention

The invention is directed to a detecting method and an apparatus related thereto and more particularly, to a method of detecting a touch position and a touch apparatus thereof.

Description of Related Art

Electronic devices or display screens having a touch function have gradually become a development trend of today's technology, and by means of the touch function, users can control the electronic apparatuses and the display screens or perform an input operation on the electronic apparatuses and the display screens. Based on the different design principles, the touch function is implemented by means of an optical touch module, a capacitive type touch module or a resistive type touch module.

Generally, a typical optical touch module is composed of two lenses. The lenses observe a touch object from different positions and then, calculate touched points based on obtained touch information, and thereby, a touch position of the touch object is obtained. In a case where a single touch object is detected, the two lenses of the optical touch module respectively outputs the obtained touch information, and touched points may be correctly obtained through cross-comparing the touch information. However, in a case where a plurality of touch objects is detected, substantially inexistent touched points (i.e., so-called ghost points) may be generated during the cross-comparing process merely according to the touch information obtained by the two lenses of the single optical touch module.

In order to prevent the ghost points from affecting the operation of the touch function, a solution is to detect the touch positions of the touch objects by using a plurality of optical touch modules, such that the optical touch modules in different directions may be capable of detecting the matched touched points for the touch positions where the touch objects are located. In other words, actually existent touched points and the ghost points can be distinguished by comparing the touched points obtained by different optical touch modules. However, in actual operation, due to difference in resolutions and disposition positions of the lenses, positional deviations may occur in the touched points, even though corresponding to the touch positions of the touch objects, obtained by the optical touch module in different directions. In this case, the touch positions of the touch objects cannot correctly determined by means of comparing.

### SUMMARY

The invention provides a method of detecting a touch position and a touch apparatus thereof capable of effectively determining substantially existent touched points and filtering out ghost points, so as to correctly detect a touch position where a touch object is located.

According to an embodiment of the invention, a method of detecting a touch position applicable to a touch apparatus having a touch surface and configured to detect a touch position of a touch object on the touch surface is provided. The method includes the following steps. At least three intervally distributed light sensing devices are provided to obtain a plurality of touch information. Each of the touch information comprises at least one peak value corresponding to each touch object. Based on the peak values of the touch information, a total number of the touched points on the touch surface is determined. If the total number of the touched points is determined as being greater than 1, the plurality of touched points on the touch surface is calculated based on the peak values of the touch information. A plurality of to-be-examined touched points corresponding to one of the peak values of first touch information is obtained from the touched points. The first touch information has the greatest number of peak values among the plurality of touch info nation. According to a plurality of distance values among the to-be-examined touched points, a first to-be-examined touched point and a second to-be-examined touched point are selected. Whether the first to-be-examined touched point and the second to-be-examined touched point are simultaneously corresponding to any one of the peak values of all the touch information is examined. If the first to-be-examined touched point and the second to-be-examined touched point are respectively and simultaneously corresponding to any one of the peak values of all the touch information, the touch position is determined according to the first to-be-examined touched point and the second to-be-examined touched point.

According to another embodiment of the invention, a touch apparatus including at least three light sensing devices, a capture module, a determination module, a calculation module, a selection module, an examine module and an output module is provided. The light sensing devices are intervally distributed around a touch surface of the touch apparatus, and configured to respectively detect a touch object on the touch surface to generate a plurality of touch information to determine a touch position of the touch object. The capture module is coupled to the light sensing devices, and controls the light sensing devices to obtain the touch information. Each of the touch information includes at least one peak value corresponding to each touch object. The determination module is coupled to the capture module, and determines a total number of the touched points on the touch surface according to the peak values of the plurality of touch information. The calculation module is coupled to the determination module, and if the total number of the touched points is determined as being greater than 1, the calculation module calculates the plurality of touched points on the touch surface based on the peak values of the touch information. The selection module is coupled to the calculation module and obtains a plurality of to-be-examined touched points corresponding to one of the peak values of first touch information from the touched points. The selection module selects a first to-be-examined touched point and a second to-be-examined touched point according to a plurality of distance values among the to-be-examined touched points. The first touch information has the greatest number of peak values among the plurality of touch information. The examine module is coupled to the selection module, and examines whether the first to-be-examined touched point and the second to-be-examined touched point are simultaneously corresponding to any one of the peak values of all the touch information. The output module is coupled to the examine module, and if the first to-be-examined touched point and the second to-be-examined touched point are respectively and simultaneously corresponding to any one of the peak values of all the touch information, the output module determines the touch position according to the first to-be-examined touched point and the second to-be-examined touched point.

To sum up, in the touch position detecting method and the touch apparatus thereof provided by the embodiments of the invention, a plurality of touch information is obtained by the at least three light sensing devices, and the total number of the touched points on the touch surface can be deduced. When the total number of the touched points is greater than 1, the touch information having the greatest number of peak values is selected from the touch information to serve as the first touch information, and the touch position corresponding to a single peak value is analyzed. To be more detailed, in the method of detecting the touch position, the first to-be-examined touched point and the second to-be-examined touched point having the greatest possibility of being the actual touched points are selected from the to-be-examined touched points corresponding to the single peak value of the first touch information and being examined. Once the first to-be-examined touched point and the second to-be-examined touched point pass the examination, a more accurate touch position can be calculated according to the first to-be-examined touched point and the second to-be-examined touched point. For all the peak values of the first touch information, the steps of the touch position detecting method can be further performed one by one to obtain the touch position corresponding to all the peak values. Thereby, actual touched points can be obtained, and the ghost points can be correctly filtered by the method of detecting the touch position and the touch apparatus thereof.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A, FIG. 1B, FIG. 1C and FIG. 1D are respectively schematic views illustrating operations of an optical touch module.

FIG. 2 is a schematic view illustrating a touch apparatus according to an embodiment of the invention.

FIG. 3 is a flowchart illustrating a touch position detecting method according to an embodiment of the invention.

FIG. 4 is a schematic view illustrating the selection of first and second to-be-examined touched points according to an embodiment of the invention.

FIG. 5 is a flowchart of examining the first and the second to-be-examined touched points according to an embodiment of the invention.

FIG. 6 is a schematic view of examining the first and the second to-be-examined touched points according to an embodiment of the invention.

### DESCRIPTION OF EMBODIMENTS

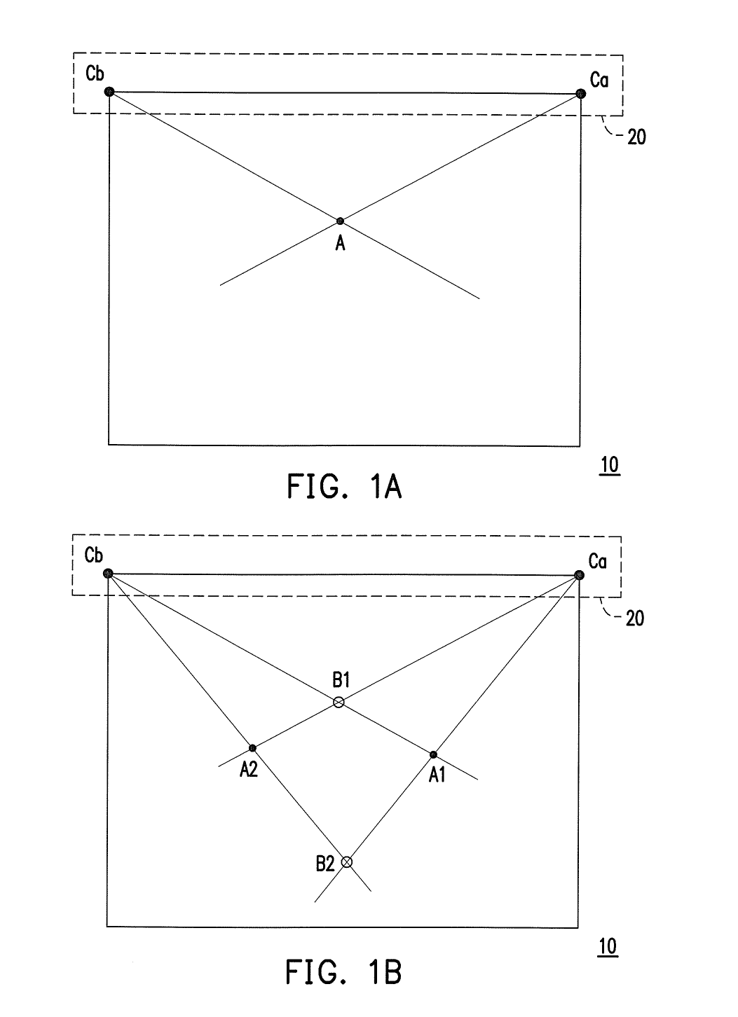

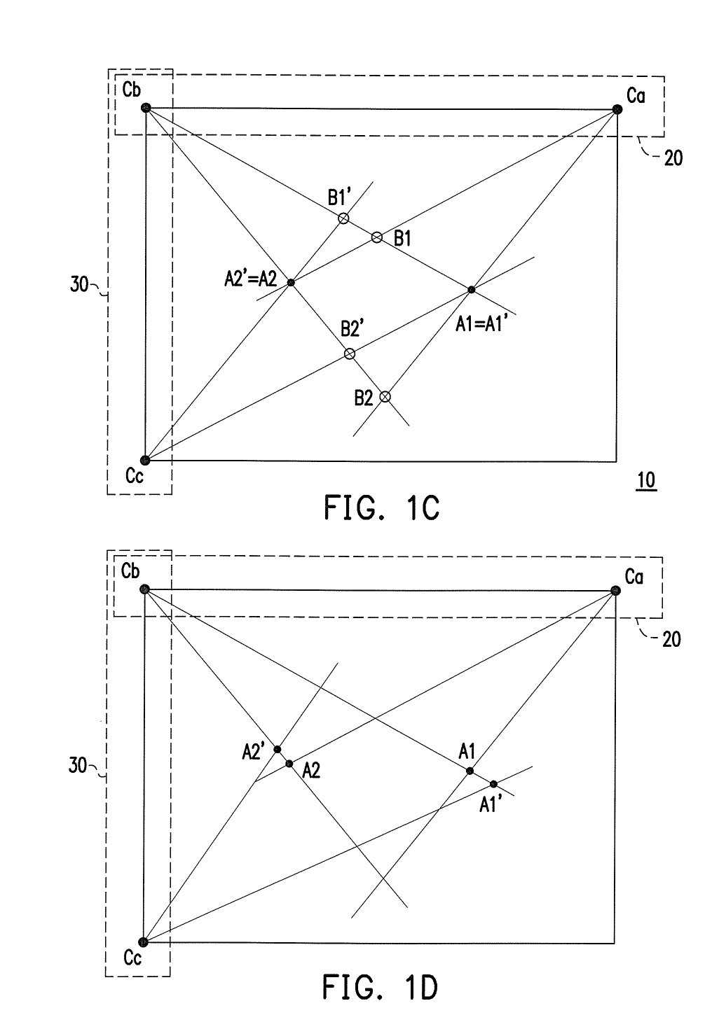

In an optical touch apparatus, ghost points have to be filtered out if touch positions of a plurality of touch objects are desired to be deduced and obtained. Specially, the ghost points are generated usually due to operations of the optical touch apparatus. FIG. 1A, FIG. 1B, FIG. 1C and FIG. 1D are respectively schematic views illustrating operations of an optical touch module. Referring to FIG. 1A, an optical touch apparatus 10 includes, for example, two optical sensing devices Ca and Cb, and the optical sensing devices Ca and Cb further form an optical touch module 20. The optical sensing devices Ca and Cb may be optical lenses, for example. In FIG. 1A, lines extending from the optical sensing devices Ca and Cb are respectively corresponding to peak values of the touch information of the optical sensing devices Ca and Cb. Generally, in a reflective type optical touch apparatus, the peak values represent brightness values of the optical sensing devices which are suddenly increased, while in a blocking type optical touch apparatus, the peak values represent brightness values of the optical sensing devices which are suddenly dropped. A touched point A, i.e., a touch position of a touch object may be obtained through cross-comparing the peak values of the touch information. In detail, in a scenario of a single touch object, each of the touch information obtained by the two optical sensing devices Ca and Cb of the optical touch module 20 includes one peak value. It should be noted that a peak value of the touch information is commonly corresponding to a substantial range of one touch information. This is because a touch object has a certain volume. In other words, the aforementioned range of the peak values is substantially corresponding to a boundary of the touch object. However, in order to obtain touched points, the range of the peak values of the touch information is decreasingly narrowed to a single point through obtaining medians during the process of obtaining the touched points.

Nevertheless, referring to FIG. 1B, if multiple touch objects appear at the same time point, each of the touch information obtained by the two optical sensing devices Ca and Cb of the optical touch module 20 may probably include a plurality of peak values. As shown in FIG. 1B, the lines extending from the optical sensing devices Ca and Cb are respectively the peak values of the touch information of the optical sensing devices Ca and Cb, and touched points A1, A2, B1 and B2 obtained through cross-comparing the peak values of the touch information may include substantially inexistent touched points B1 and B2, which are so-called ghost points B1 and B2.

Ghost points would cause malfunction in touch operations, and thus, it is important to filter out the ghost points. A common method is to detect the touched points by using multiple optical touch modules for filtering out the ghost points. Referring to FIG. 1C, the optical touch module 20 includes the two optical sensing devices Ca and Cb, and an optical touch module 30 includes two optical sensing devices Cb and Cc. When detecting touch positions of a plurality of touch objects, the optical touch module 20 obtains touched points, for example, A1, A2, B1 and B2, and the optical touch module 30 obtains touched points, for example, A1′, A2′, B1′ and B2′. As shown in FIG. 1C, lines extending from the optical sensing devices Ca, Cb and Cc are respectively corresponding to peak values of the touch information of the optical sensing devices Ca, Cb and Cc, such that touched points A1, A2, B1, B2, A1′, A2′, B1′ and B2′ may be obtained through cross-comparing the peak values of the touch information. Positions of the touched points A1 and A2 match positions of the touched points A1′ and A2′, but a distance between B1 and B1′ and a distance between B2 and B2′ are large, and thereby, it may be determined that the touched points A1 and A2 (A1′ and A2′) are actual touched points.

However, in actual use, the arrangement of the lenses may be affected by resolution and assembly offsets, such that the touched points measured by different optical touch modules would essentially lead to deviations. Referring to FIG. 1D, even for the actually existent touch positions of the touch objects, the touched points A1 and A2 obtained by the optical touch module 20 have positional deviations from the touched points A1′ and A2′ obtained by the optical touch module 30. In this case, the touch positions of the touch objects may not be correctly determined, such that the ghost points may also not be correctly recognized nor filtered.

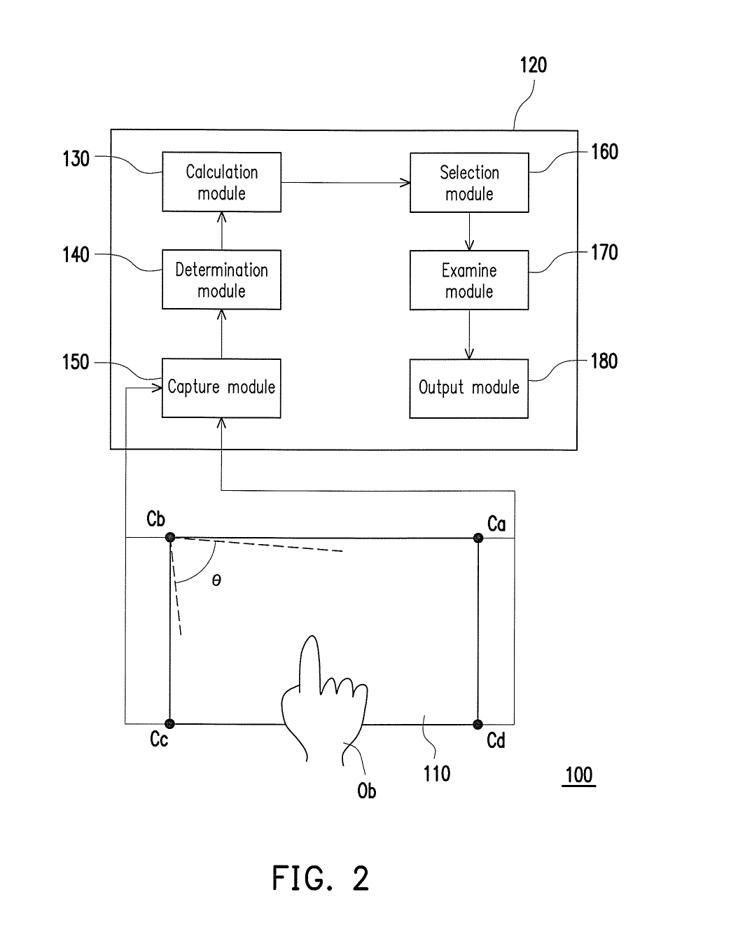

FIG. 2 is a schematic view illustrating a touch apparatus according to an embodiment of the invention. Referring to FIG. 2, a touch apparatus 100 is, for example, an optical touch panel or an optical touch screen, which may be disposed in an electronic apparatus, such as a desktop computer, a notebook computer, a smart mobile apparatus, a display, a television, an advertising billboard, an electronic whiteboard, and configured to provide a touch function. The touch apparatus 100 has a touch surface 110. A touch object Ob may touch or floating-touch the touch surface 110 and move on the touch surface 110 to control the aforementioned electronic apparatus. In some embodiments, the touch surface 110 of the touch apparatus 100 may be integrated with a display device (not shown) to provide image information. The display device may be, for example, a liquid crystal display (LCD), a light-emitting diode (LED) display, a field emission display (FED), but the invention is not limited thereto.

The touch apparatus 100 includes a plurality of light sensing devices. In the present embodiment, four light sensing devices Ca, Cb, Cc and Cd are, for example, optical lenses including photosensitive elements, such as charge coupled devices (CCD) or other complementary metal oxide semiconductors (CMOS). Referring to FIG. 2, the light sensing devices Ca, Cb, Cc and Cd are disposed around the touch surface 110, such as at four corners of the touch surface 110, but the invention is not limited thereto. The light sensing devices Ca, Cb, Cc and Cd respectively perform image-capturing to obtain a plurality of touch information. An embodiment with four light sensing devices will be provided for description for example; however, for persons with ordinary skill in the art, an embodiment with at least three light sensing devices (which are disposed at three corners of the touch surface, for example) may satisfy the invention, while embodiments with more than four light sensing devices shall not be excluded.

To be specific, the touch information generally include brightness information detected by the light sensing devices Ca, Cb, Cc and Cd within detection ranges thereof, and a detection range of each of light sensing devices Ca, Cb, Cc and Cd may be, for example, an angle range of 0 degrees. Taking the embodiment illustrated in FIG. 2 as an example, when the touch object Ob touches the touch surface 110, the touch information of each of the light sensing devices Ca, Cb, Cc and Cd presents a peak value in a corresponding angle, where the peak value may be positive or negative, depending on whether the touch apparatus 100 is a reflective or a blocking type.

The touch apparatus 100 further includes a capture module 130, a determination module 140, a calculation module 150, a selection module 160, an examine module 170 and an output module 180 which are configured to receive the touch information captured by the light sensing devices Ca, Cb, Cc and Cd and perform relative procedures to obtain a touch position of the touch object Ob. In the present embodiment, the capture module 130, the determination module 140, the calculation module 150, the selection module 160, the examine module 170 and the output module 180 are, for example, a plurality of software procedures performed by a processing unit 120. The processing unit 120 may be, for example, a programmable microprocessor, a digital signal processor (DSP), a programmable controller, application specific integrated circuits (ASIC), a programmable logic device (PLD) or the like. However, in other embodiments, the capture module 130, the determination module 140, the calculation module 150, the selection module 160, the examine module 170 and the output module 180 may also be implemented by a plurality of circuits.

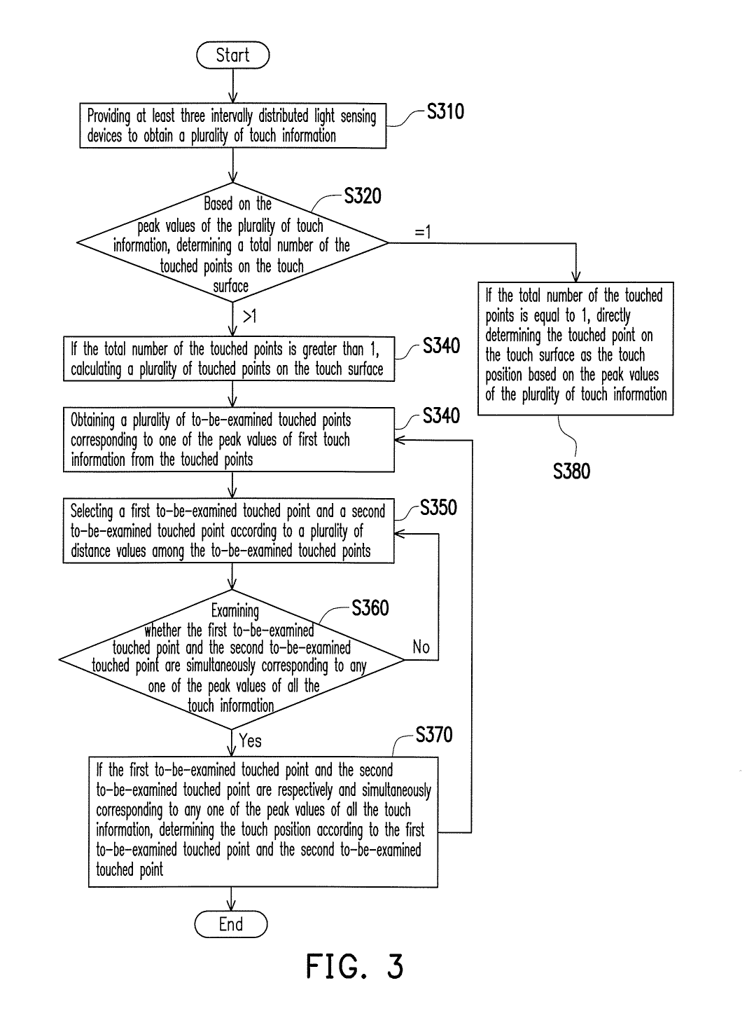

FIG. 3 is a flowchart illustrating a touch position detecting method according to an embodiment of the invention. The touch position detecting method of the present embodiment is applicable to the touch apparatus 100 illustrated in FIG. 2. Referring to FIG. 2 and FIG. 3, in step S310, the capture module 130 controls the light sensing devices Ca, Cb, Cc and Cd to obtain a plurality of touch information. As described above, the touch information is the brightness information detected by the light sensing devices Ca, Cb, Cc and Cd within the detection ranges thereof. Generally, a peak value of each of the touch information represents that there is a touch object in a corresponding angle and a plurality of peak values represent the existence of a plurality of touch objects.

Then, in step S320, the determination module 140 determines total a number of the touched points on the touch surface 110 based on a plurality of peak values of the touch information. To be detailed, the determination module 140 performs cross-comparing based on a total number of the peak values of each touch information, so as to calculate the total number of the touched points on the touch surface 110. If the determination module 140 determines that the total number of the touched point on the touch surface 110 is equal to 1, as illustrated in FIG. 1A, the touch position detecting method does not need to perform a step of determining and filtering out ghost points. In this case, in step S380, the calculation module 150 directly calculates a single touched point on the touch surface 110 based on a peak value of the touch information, and the touched point is determined as a touch position of the touch object.

In contrast, if the determination module 140 determines that the total number of the touched points is more than 1, as illustrated in FIG. 1B and FIG. 1C, in step S330, the calculation module 150 calculate a plurality of touched points on the touch surface 110 based on peak values of the touch information. The touched points may be presented in a form of, for example, coordinate points based on the touch surface 110. To be more detailed, the calculation module 150 obtains the touched points on the touch surface 110 by cross-comparing any one of the peak values of the touch information with any one of the peak values of the another touch information. For example, as illustrated in FIG. 1C, peak values of the touch information obtained by the light sensing device Ca may be cross-compared with peak values of the touch information obtained by the light sensing device Cb to obtain touched points A1, A2, B1 and B2. On the other hand, the peak values of the touch information obtained by the light sensing device Cb may be cross-compared with peak values of the touch information obtained by the light sensing device Cc to obtain touched points A1′, A2′, B1′ and B2′.

Referring to FIG. 3 again, after the touched points on the touch surface are obtained, in step S340, the selection module 160 obtains a plurality of to-be-examined touched points corresponding to one of the peak values of first touch information from the plurality of touched points. The first touch information is the touch information having the greatest number of overlapping peak values of a plurality of touch information obtained by the light sensing devices Ca, Cb, Cc and Cd. Then, in step S350, the selection module 160 selects a first to-be-examined touched point and a second to-be-examined touched point according to a plurality of distance values among a plurality of to-be-examined touched points.

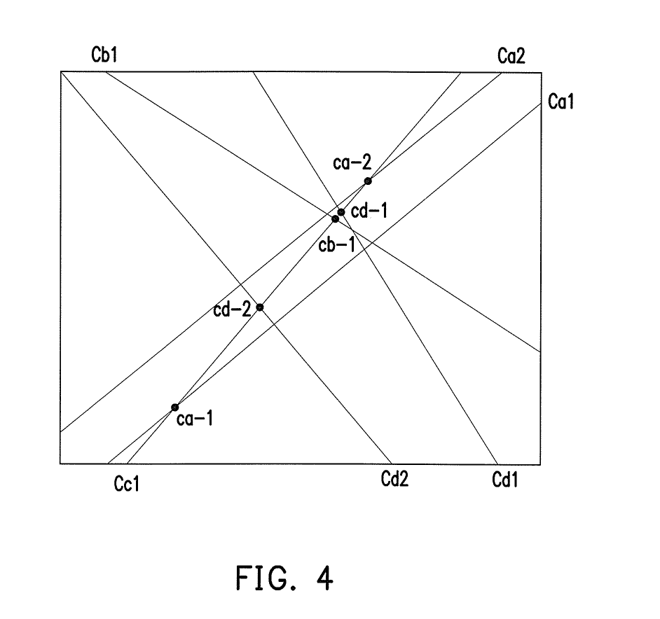

FIG. 4 is a schematic view illustrating the selection of first and second to-be-examined touched points according to an embodiment of the invention. Referring to FIG. 2, FIG. 3 and FIG. 4, after determining that the touch information of the light sensing device Cc has the greatest number of overlapping peak values, the selection module 160 selects the touch information of the light sensing device Cc as the first touch information. In other embodiments of the invention, in case multiple light sensing devices simultaneously have the touch information with the greatest number of peak values, the selection module 160 may, for example, randomly select one of the touch information as the first touch information.

After the first touch information is selected, the selection module 160 further selects a plurality of to-be-examined touched points ca-1, ca-2, cb-1, cd-1 and cd-2 corresponding to one of the peak values of the first touch information from the touched points. As illustrated in FIG. 4, a solid line Cc1 is corresponding to one of the peak values of the first touch information, while each of the other solid lines Ca1, Ca2, Cb1, Cd1 and Cd2 is respectively to one of the peak values of the touch information of the light sensing devices Ca, Cb and Cd. The solid line Cc1 intersects with the other solid lines Ca1, Ca2, Cb1, Cd1 and Cd2 to generate the multiple to-be-examined touched points ca-1, ca-2, cb-1, cd-1 and cd-2. In the present embodiment, the selection module 160 further calculates distance values between each two of the to-be-examined touched points ca-1, ca-2, cb-1, cd-1, cd-2, and selects the to-be-examined touched points cb-1 and cd-1 with the smallest distance value therebetween as the first to-be-examined touched point cb-1 and the second to-be-examined touched point cd-1.

Generally, the touched points corresponding to the same touch object, but obtained by combinations of different light sensing devices may have deviations among one another, but will not be different too far. Therefore, in the touch position detecting method of the present embodiment, when the first to-be-examined touched point and the second to-be-examined touched point are selected, two of the to-be-examined touched points having the smallest distance from each other are selected as the first to-be-examined touched point and the second to-be-examined touched point, but the invention is not limited thereto, and the first to-be-examined touched point and the second to-be-examined touched point may also be selected from the plurality of to-be-examined touched points according to other standards. Then, referring to FIG. 3 again, in step S360, the examine module 170 examines whether the first to-be-examined touched point and the second to-be-examined touched point are also corresponding to any one of the peak values of each of all the touch information.

That is to say, to each of the touch information, it is determined that whether any one of the peak values is corresponding to the first to-be-examined touched point, and whether any one of the peak values is corresponding to the second to-be-examined touched point. In other words, taking FIG. 4 for example, the examine module 170 examines whether both the first to-be-examined touched point cb-1 and the second to-be-examined touched point cd-1 are actually existent touched points.

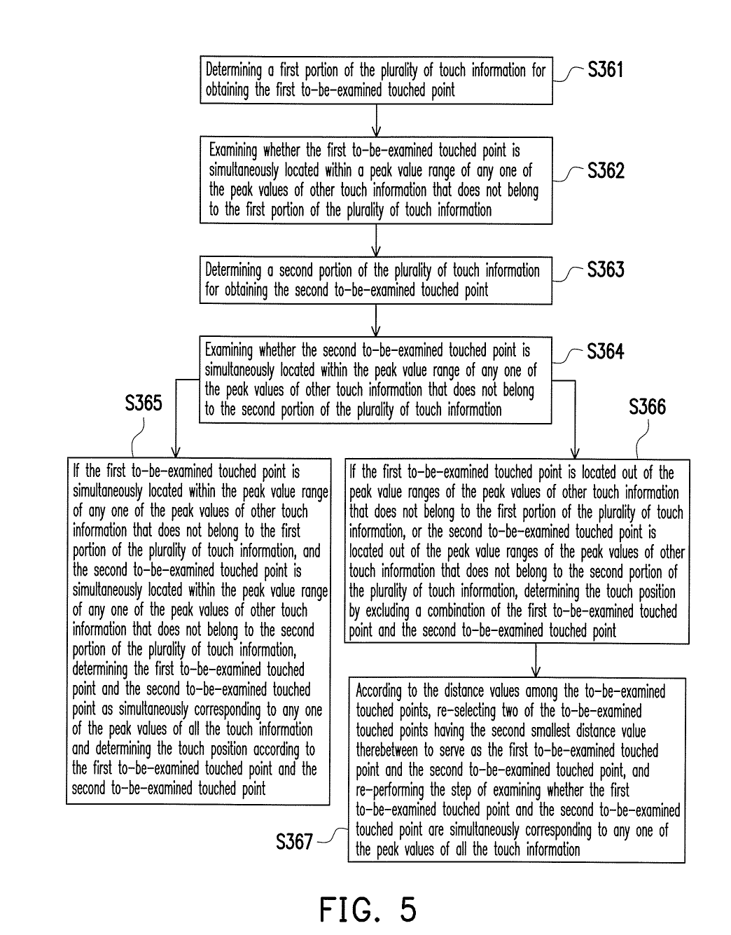

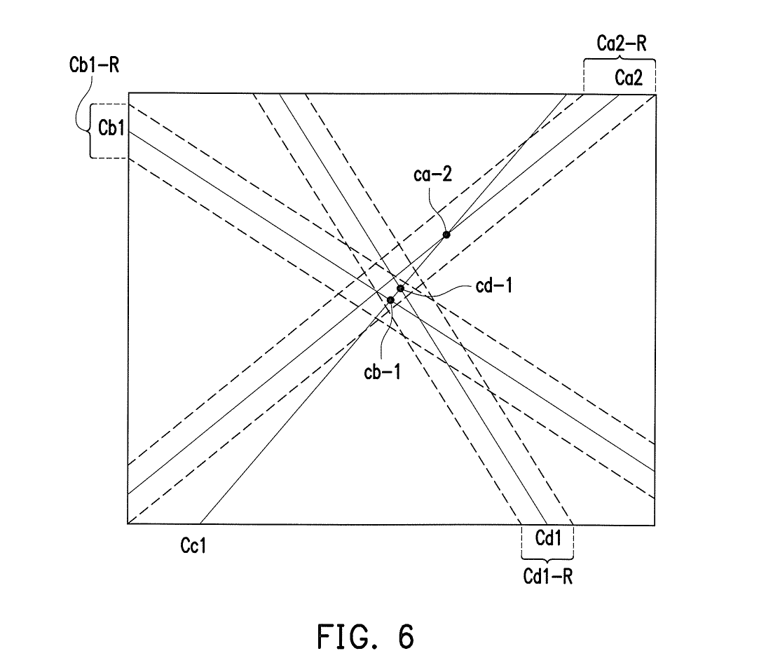

FIG. 5 is a flowchart of examining the first and the second to-be-examined touched points according to an embodiment of the invention. FIG. 6 is a schematic view of examining the first and the second to-be-examined touched points according to an embodiment of the invention. Referring to FIG. 4, FIG. 5 and FIG. 6, in step S361, a first portion of the touch information for obtaining the first to-be-examined touched point is obtained. In the present embodiment, the first to-be-examined touched point cb-1 is an intersection point of the solid line Cc1 and the solid line Cb1. In other words, the first to-be-examined touched point cb-1 is obtained through cross-comparing the peak values of the touch information of the light sensing device Cc and the peak values of the touch information of the light sensing device Cb. Thus, the first portion of the touch information includes the touch information of the light sensing devices Cb and Cc.

Afterwards, in step S362, whether the first to-be-examined touched point is also simultaneously located in a peak value range of any one of the peak values of other touch information that does not belong to the first portion of the touch information is examined. Referring to FIG. 6, the first to-be-examined touched point cb-1 is obtained based on the touch information of the light sensing devices Cb and Cc, and thus, whether the first to-be-examined touched point cb-1 is also located in ranges of the peak values of the touch information of the light sensing devices Ca and Cd is then examined. As described above, each of the peak values of the touch information is usually corresponding to a substantial range of the touch information. During the examination process, only whether the first to-be-examined touched point cb-1 falls within ranges of the peak values of the touch information of the light sensing devices Ca and Cd is determined. According to the embodiment illustrated in FIG. 6, the first to-be-examined touched point cb-1 simultaneously falls within peak value ranges Cd1-R and Ca2-R.

Being similar to steps S361 and S362, in step S363, a second portion of the touch information for obtaining the second to-be-examined touched point is determined. In the present embodiment, the second to-be-examined touched point cd-1 is an intersection point of the solid line Cc1 and the solid line Cd1. In other words, the second to-be-examined touched point cd-1 is obtained through cross-comparing the peak values of the touch information of the light sensing device Cc and the peak values of the touch information of the light sensing device Cd. Thus, the second portion of the touch information includes the touch information of the light sensing devices Cc and Cd. Afterwards, in step S364, whether the second to-be-examined touched point is located in the peak value range of any one of the peak values of other touch information that does not belong to the second portion of the touch information is also examined. Namely, as for the preceding embodiment, whether the second to-be-examined touched point cd-1 is also located in ranges of the peak values of the touch information of the light sensing devices Ca and Cb is also examined. According to the embodiment illustrated in FIG. 6, the second to-be-examined touched point cd-1 also falls within the peak value ranges Cb1-R and Ca2-R.

In step S365, if the first to-be-examined touched point is simultaneously located in the peak value range of any one of the peak values of other touch information that does not belong to the first portion of the touch information, and the second to-be-examined touched point is simultaneously located in the peak value range of any one of the peak values of other touch information that does not belong to the second portion of the touch information, it is determined that the first to-be-examined touched point and the second to-be-examined touched point are simultaneously corresponding to any one of the peak values of all the touch information. With reference to the embodiment illustrated in FIG. 6, the first to-be-examined touched point cb-1 falls within the peak value ranges Cd1-R and Ca2-R simultaneously, and the second to-be-examined touched point cd-1 also falls within the peak value ranges Cd1-R and Ca2-R simultaneously, it indicates that the first to-be-examined touched point cb-1 and the second to-be-examined touched point cd-1 may be corresponding to any peak values of all the touch information.

Referring to FIG. 3 again, in step S370, if the first to-be-examined touched point and the second to-be-examined touched point are respectively and simultaneously corresponding to any one of the peak values of all the touch information, the output module 180 determines the touch position according to the first to-be-examined touched point and the second to-be-examined touched point. Namely, taking FIG. 4 for example, the touch position of the touch object is determined according to the first to-be-examined touched point cb-1 and the second to-be-examined touched point cd-1. In the present embodiment, positions (or coordinate points) of the first to-be-examined touched point cb-1 and the second to-be-examined touched point cd-1 on the touch surface 110 are averaged to determine the touch position of the touch object.

Referring to FIG. 5 again, in step S366, if the first to-be-examined touched point is located out of the peak value ranges of the peak values of other touch information that does not belong to the first portion of the touch information, or the second to-be-examined touched point is located out of the peak value ranges of the peak values of other touch information that does not belong to the second portion of the touch information, the examine module 170 determines the touch position by excluding a combination of the first to-be-examined touched point and the second to-be-examined touched point. In this case, referring to FIG. 3, the touch position detecting method returns to step S350, and the selection module 160 selects two to-be-examined touched points with the second smallest distance therebetween according to the distance values among the to-be-examined touched points to serve as the first to-be-examined touched point and the second to-be-examined touched point. For example, if the first to-be-examined touched point cb-1 of the preceding embodiment is not located within the ranges of the peak values of the touch information of the light sensing devices Ca, Cd, or the second to-be-examined touched point cd-1 is not located within the ranges of the peak values of the touch information of the light sensing devices Ca, Cb, the examine module 170 excludes the combination of the first to-be-examined touched point cb-1 and the second to-be-examined touched point cd-1. Then, the selection module 160 re-selects the first to-be-examined touched point and the second to-be-examined touched point according to the distance values among the to-be-examined touched points. In this case, since the combination of the touched points cb-1 and cd-1 has been excluded, the selection module 160 selects a combination of two of the to-be-examined touched points ca-1, ca-2, cb-1, cd-1 and cd-2 which have the second smallest distance value therebetween, e.g., a combination of the to-be-examined touched points ca-2 and cd-1, to serve as the first to-be-examined touched point and the second to-be-examined touched point, and the examine module 170 performs the following process of the touch position detecting method. Steps S350 and S360 of the touch position detecting method will be continuously performed until the touch apparatus 100 selects the suitable first and second to-be-examined touched points from the to-be-examined touched points.

In the embodiments above, after determining a touch position corresponding to a peak value (e.g., the solid line Cc1) of the first touch information (e.g., the touch information of the light sensing device Cc), the touch apparatus 100 further determines a touch position corresponding to another peak value of the first touch information. In this case, as for the touch position detecting method illustrated in FIG. 3, the method returns from step S370 to step S340 to re-calculate the touch position corresponding to another peak value of the first touch information. In other words, the touch apparatus 100 calculates the touch position corresponding to each peak value in the first touch information. After obtaining the touch positions of all the touch objects, the touch apparatus 100 ends the touch position detecting method. In an embodiment of the invention, the touch apparatus 100 waits for a fixed cycle and re-performs the touch position detecting method.

To summarize, in the touch position detecting method and the touch apparatus thereof provided by the embodiments of the invention, a plurality of touch information is obtained by the at least three light sensing devices, and the total number of the touched points and all possible touched points on the touch surface can be deduced. Then, for each touch object, the most possible multiple touched points are correspondingly selected and examined for mathematical calculation to recognize the touch positions of the touch objects. Accordingly, the touch position detecting method and the touch apparatus thereof can filter out the ghost points on the touch surface and accurately determine the touch positions of the touch objects, so as to achieve better touch detection.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of detecting a touch position, adapted for a touch apparatus having a touch surface to detect a touch position of a touch object on the touch surface, the method comprising:
providing at least three intervally distributed light sensing devices to obtain a plurality of touch information, each of the touch information comprises at least one peak value corresponding to each touch object;
determining a total number of touched points on the touch surface based on the peak values of the plurality of touch information;
if the total number of the touched points is determined as being greater than 1, calculating the plurality of touched points on the touch surface based on the peak values of the plurality of touch information;
obtaining a plurality of to-be-examined touched points corresponding to one of the peak values of first touch information from the touched points, wherein the first touch information has the greatest number of peak values among the plurality of touch information;
selecting a first to-be-examined touched point and a second to-be-examined touched point according to a plurality of distance values among the to-be-examined touched points;
examining whether the first to-be-examined touched point and the second to-be-examined touched point are simultaneously corresponding to any one of the peak values of all the touch information; and
if the first to-be-examined touched point and the second to-be-examined touched point are respectively and simultaneously corresponding to any one of the peak values of all the touch information, determining the touch position according to the first to-be-examined touched point and the second to-be-examined touched point.

2. The touch position detecting method according to claim 1, wherein the touch positions corresponding to each of the peak values in the first touch information are calculated.

3. The touch position detecting method according to claim 1, further comprising:
if the total number of the touched point is determined as being equal to 1, directly determining the touched point on the touch surface as the touch position based on the peak values of the plurality of touch information.

4. The touch position detecting method according to claim 1, wherein the step of calculating the touched points on the touch surface further comprises:
cross-comparing any one of the peak values in one of the touch information with any one of the peak values in another one of the touch information to obtain the touched point on the touch surface.

5. The touch position detecting method according to claim 1, wherein the step of selecting the first to-be-examined touched point and the second to-be-examined touched point further comprises:
calculating the distance values among the to-be-examined touched points; and
selecting two to-be-examined touched points with the smallest distance value therebetween from the to-be-examined touched points to serve as the first to-be-examined touched point and the second to-be-examined touched point.

6. The touch position detecting method according to claim 1, wherein the step of examining whether the first to-be-examined touched point and the second to-be-examined touched point are simultaneously corresponding to any one of the peak values of all the touch information further comprises:
determining a first portion of the plurality of touch information for obtaining the first to-be-examined touched point;
examining whether the first to-be-examined touched point is simultaneously located within a peak value range of any one of the peak values of other touch information that does not belong to the first portion of the plurality of touch information;
determining a second portion of the plurality of touch information for obtaining the second to-be-examined touched point;
examining whether the second to-be-examined touched point is simultaneously located within the peak value range of any one of the peak values of other touch information that does not belong to the second portion of the plurality of touch information; and
if the first to-be-examined touched point is simultaneously located within the peak value range of any one of the peak values of other touch information that does not belong to the first portion of the plurality of touch information, and the second to-be-examined touched point is simultaneously located within the peak value range of any one of the peak values of other touch information that does not belong to the second portion of the plurality of touch information, determining the first to-be-examined touched point and the second to-be-examined touched point as simultaneously corresponding to any one of the peak values of all the touch information and determining the touch position according to the first to-be-examined touched point and the second to-be-examined touched point.

7. The touch position detecting method according to claim 6, further comprising:
if the first to-be-examined touched point is located out of the peak value ranges of the peak values of other touch information that does not belong to the first portion of the plurality of touch information, or the second to-be-examined touched point is located out of the peak value ranges of the peak values of other touch information that does not belong to the second portion of the plurality of touch information, determining the touch position by excluding a combination of the first to-be-examined touched point and the second to-be-examined touched point; and
according to the distance values among the to-be-examined touched points, re-selecting two of the to-be-examined touched points having the second smallest distance value therebetween to serve as the first to-be-examined touched point and the second to-be-examined touched point, and re-performing the step of examining whether the first to-be-examined touched point and the second to-be-examined touched point are simultaneously corresponding to any one of the peak values of all the touch information.

8. A touch apparatus, comprising:
at least three light sensing devices, intervally distributed around a touch surface of the touch apparatus, and configured to respectively detect a touch object on the touch surface to generate a plurality of touch information to determine a touch position of the touch object;
a capture module, coupled to the light sensing devices, and controlling the light sensing devices to obtain the plurality of touch information, wherein each of the touch information comprises at least one peak value corresponding to each touch object;
a determination module, coupled to the capture module, and determining a total number of touched points on the touch surface according to the peak values of the plurality of touch information;
a calculation module, coupled to the determination module, and if the determination module determines that the total number of the touched points is greater than 1, the calculation module calculating the plurality of touched points on the touch surface based on the peak values of the plurality of touch information;
a selection module, coupled to the calculation module, obtaining a plurality of to-be-examined touched points corresponding to one of the peak values of first touch information from the touched points, and selecting a first to-be-examined touched point and a second to-be-examined touched point according to a plurality of distance values among the to-be-examined touched points, wherein the first touch information has the greatest number of peak values among the plurality of touch information;
an examine module, coupled to the selection module, and examining whether the first to-be-examined touched point and the second to-be-examined touched point are simultaneously corresponding to any one of the peak values of all the touch information; and
an output module, coupled to the examine module, and if the first to-be-examined touched point and the second to-be-examined touched point are respectively and simultaneously corresponding to any one of the peak values of all the touch information, the output module determining the touch position according to the first to-be-examined touched point and the second to-be-examined touched point.

9. The touch apparatus according to claim 8, wherein the touch apparatus calculating the touch positions corresponding to each of the peak values in the first touch information.

10. The touch apparatus according to claim 8, wherein if the determination module determines that the total number of the touched point is equal to 1, the calculation module directly determines the touched point on the touch surface as the touch position based on the peak values of the plurality of touch information.

11. The touch apparatus according to claim 8, wherein the calculation module cross-compares any one of the peak values in one of the touch information with any one of the peak values in another one of the touch information to obtain the touched point on the touch surface.

12. The touch apparatus according to claim 8, wherein the selection module calculates the distance values among the to-be-examined touched points, and selects two to-be-examined touched points with the smallest distance value therebetween from the to-be-examined touched points to serve as the first to-be-examined touched point and the second to-be-examined touched point.

13. The touch apparatus according to claim 8, wherein the examine module determines a first portion of the plurality of touch information for obtaining the first to-be-examined touched point, and examines whether the first to-be-examined touched point is simultaneously located within a peak value range of any one of the peak values of other touch information that does not belong to the first portion of the plurality of touch information; the examine module determines a second portion of the plurality of touch information for obtaining the second to-be-examined touched point, and examines whether the second to-be-examined touched point is simultaneously located within the peak value range of any one of the peak values of other touch information that does not belong to the second portion of the plurality of touch information;
if the first to-be-examined touched point is simultaneously located within the peak value range of any one of the peak values of other touch information that does not belong to the first portion of the plurality of touch information, and the second to-be-examined touched point is simultaneously located within the peak value range of any one of the peak values of other touch information that does not belong to the second portion of the plurality of touch information, the examine module determines the first to-be-examined touched point and the second to-be-examined touched point as simultaneously corresponding to any one of the peak values of all the touch information and determines the touch position according to the first to-be-examined touched point and the second to-be-examined touched point.

14. The touch apparatus according to claim 13, wherein if the first to-be-examined touched point is located out of the peak value ranges of the peak values of other touch information that does not belong to the first portion of the plurality of touch information, or the second to-be-examined touched point is located out of the peak value ranges of the peak values of other touch information that does not belong to the second portion of the plurality of touch information, the examine module determines the touch position by excluding a combination of the first to-be-examined touched point and the second to-be-examined touched point, and the selection module, according to the distance values among the to-be-examined touched points, reselects two of the to-be-examined touched points having the second smallest distance value therebetween to serve as the first to-be-examined touched point and the second to-be-examined touched point, and the examine module re-examines whether the first to-be-examined touched point and the second to-be-examined touched point are simultaneously corresponding to any one of the peak values of all the touch information.
